(19) United States
(12) Patent Application Publication
(10) Pub. No.: US 2017/0033424 A1
(43) Pub. Date: Feb. 2, 2017

(54) DUAL-MODE MICROWAVE TUNABLE FILTER

(71) Applicant: Electronics and Telecommunications Research Institute, Daejeon (KR)

(72) Inventors: Chang Soo KWAK, Daejeon (KR); Man Seok Uhm, Daejeon (KR); In Bok Yom, Daejeon (KR); So Hyeun Yun, Daejeon (KR); Hong Yeol Lee, Cheongju-si (KR)

(73) Assignee: Electronics and Telecommunications Research Institute, Daejeon (KR)

(21) Appl. No.: 15/140,648

(22) Filed: Apr. 28, 2016

(30) Foreign Application Priority Data
Jul. 31, 2015 (KR) 10-2015-0108761

(51) Int. Cl. H01P 1/208

(52) U.S. Cl. CPC H01P 1/208

(57) ABSTRACT

A dual-mode filter is provided. A filter may include a cylindrical cavity configured to implement resonance modes with a plurality of different resonant frequencies, and a plurality of slot irises formed on a side of the cylindrical cavity, and the plurality of slot irises may be arranged asymmetrically to each other with respect to the cylindrical cavity.

### CROSS-REFERENCE TO RELATED APPLICATION

This application claims the benefit of Korean Patent Application No. 10-2015-0108761, filed on Jul. 31, 2015, in the Korean Intellectual Property Office, the disclosure of which is incorporated herein by reference.

### BACKGROUND

1. Field of the Invention

Embodiments relate to a dual-mode microwave tunable filter, and more particularly, to a mechanical tunable filter used in a flexible broadcasting system or a communication system that enables a change in a bandwidth or a frequency of a channel during an operation.

2. Description of the Related Art

Recently, a broadcasting and/or communication system is beginning to employ a flexible system to efficiently use limited frequency resources. The flexible system may allow resources (for example, a bandwidth or power) of a channel with less traffic to be used by a channel with great traffic. A filter used in the above system may need to change a frequency or a bandwidth depending on circumstances.

Tunable filters may be classified into electrically tunable filters and mechanically tunable filters. An electrically tunable filter may have a high speed of response, may be small in size and weight and may consume less power, however, an extremely high insertion loss may occur and the power is limited. On the contrary, in comparison to the electrically tunable filter, a mechanically tunable filter may be relatively bulky and heavy and may consume more power, however, an extremely low insertion loss may occur and high power may be handled. Because a tunable filter to be used in an output terminal of the broadcasting and/or communication system needs to have an extremely low insertion loss and to handle high power, only the mechanically tunable filter may be currently used.

As a mechanical tunable filter released up to date, a tunable filter implemented using a TE₀₁₁ mode may be used. The tunable filter may be implemented by a scheme of implementing a band-pass filter by connecting a high-pass filter and a low-pass filter using an isolator. The high-pass filter and the low-pass filter may have a structure to change only a central frequency while maintaining other performances, and may change a bandwidth and a center frequency of the resultant band-pass filter by adjusting positions and a distance between center frequencies of the two filters. By using the TE₀₁₁ mode, an extremely high quality (Q)-factor may be implemented.

Also, for example, a tunable band-pass filter may be implemented using only a single filter. The tunable band-pass filter may use a scheme of realizing coupling between resonators using a resonator (for example, a coupling resonator) having a resonant frequency higher than an operating frequency, instead of using an iris, and of adjusting an amount of coupling between the resonators by changing a resonant frequency of a coupling resonator. By individually adjusting a resonant frequency of a main resonator and a resonant frequency of another resonator coupled to the main resonator, a band-pass filter having a desired central frequency and a desired bandwidth may be implemented. The above tunable filter may be an ideal tunable filter because an isolator is not required and it is possible to adjust all parameters of the band-pass filter. However, an extremely large number of driving devices are required to individually control all resonators and coupling, and accordingly a weight, a volume and an amount of power to be used may increase. Also, when a size of a filter is reduced for a high frequency band, driving motors may need to be reduced in size due to a reduction in a gap between the driving motors. However, it is difficult to reduce a size of a motor below a predetermined size.

### SUMMARY

Embodiments may provide a filter having a volume and a weight reduced by implementing a tunable high-pass filter or a tunable low-pass filter as a dual-mode filter based on a method of implementing a tunable band-pass filter using a tunable high-pass filter, a tunable low-pass filter and an isolator.

According to an aspect, there is provided a filter including a cylindrical cavity configured to implement a resonance mode with a plurality of different resonant frequencies, and a plurality of slot irises formed on a side of the cylindrical cavity. The plurality of slot irises may be arranged asymmetrically to each other with respect to the cylindrical cavity.

A difference between the plurality of different resonant frequencies may be determined based on relative positions of the plurality of slot irises.

A transmission zero may be added by inducing an offsetting action between a used mode and a neighboring mode by adjusting the relative positions of the plurality of slot irises.

The plurality of different resonant frequencies may be simultaneously changed by moving either a top or a bottom of the cylindrical cavity or both. Accordingly, resonant frequencies of a plurality of resonance modes formed by the cylindrical cavity may be set to desired frequencies by a change in a height of the cylindrical cavity and relative positions of slot irises.

The filter may further include a tuning screw inserted into the side of the cylindrical cavity. The difference between the plurality of different resonant frequencies may be adjusted based on a diameter of the tuning screw or a depth by which the tuning screw is inserted into the cylindrical cavity.

According to another aspect, there is provided a filter including a basic filter, and an additional cavity configured to add a transmission zero to the basic filter, wherein the basic filter includes a cylindrical cavity configured to implement a resonance mode with a plurality of different resonant frequencies, and a plurality of slot irises formed on a side of the cylindrical cavity, and wherein the basic filter and the additional cavity are connected through a slot iris.

A difference between the plurality of different resonant frequencies may be determined based on relative positions of the plurality of slot irises.

A transmission zero may be added by inducing an offsetting action between a used mode and a neighboring mode by adjusting the relative positions of the plurality of slot irises.

The additional cavity may have a cylindrical shape.

The additional cavity may have a hexahedral shape.

The plurality of slot irises may be arranged asymmetrically to each other with respect to the cylindrical cavity in the basic filter.

Central frequencies corresponding to the different resonant frequencies may be changed by moving either a top or a bottom of the cylindrical cavity in the basic filter or both and simultaneously moving either a top or a bottom of the additional cavity or both.

Accordingly, a plurality of resonant frequencies formed by the cylindrical cavity may be set to desired frequencies by a change in a height of the cylindrical cavity and relative positions of slot irises.

A frequency of the added transmission zero may be adjusted by moving either a top or a bottom of the additional cavity or both.

The filter may further include a tuning screw inserted into the side of the cylindrical cavity in the basic filter. The difference between the plurality of different resonant frequencies may be adjusted based on a diameter of the tuning screw or a depth by which the tuning screw is inserted into the cylindrical cavity.

### Effect

According to embodiments, it is possible to reduce a volume and weight of a main body of a filter by implementing a tunable high-pass filter or a tunable low-pass filter as a dual-mode filter based on a method of implementing a tunable band-pass filter using a tunable high-pass filter, a tunable low-pass filter and an isolator.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a filter according to an embodiment;

FIG. 2 is a diagram illustrating two TE₂₁₁ modes that have different resonant frequencies and in which slot irises are arranged at a specific angle on a side of a cylindrical cavity according to an embodiment;

FIG. 3 is a graph illustrating a difference between two different resonant frequencies determined based on a change in an angle θₚₒᵣₜ between slot irises according to an embodiment;

FIG. 4 is a graph illustrating a result of a design of a dual-mode microwave filter using TE₂₁₁ modes according to an embodiment;

FIG. 5 illustrates a shape of a filter including a TE₀₁₁ mode to add a transmission zero according to an embodiment;

FIG. 6 illustrates a filter coupling structure to add a transmission zero, and design result of the filter according to an embodiment;

FIG. 7 is a graph illustrating a result of a design of a filter with a sharper roll-off due to an addition of a TE₀₁₁ mode cavity according to an embodiment; and

FIG. 8 illustrates a result of a change in a central frequency of a tunable filter using a TE₂₁₁ mode according to an embodiment.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

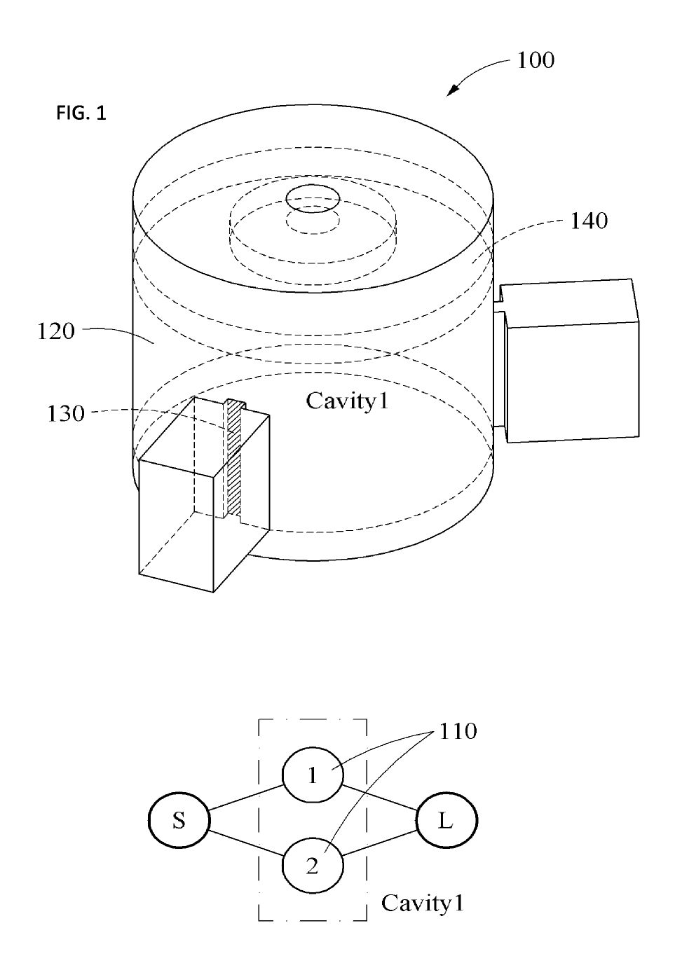

FIG. 1 is a diagram illustrating a filter 100 according to an embodiment.

The filter 100 may include a cylindrical cavity 120, a plurality of slot irises 130, and a piston 140. A plurality of resonance modes 110 may be implemented by the cylindrical cavity 120, and may have a plurality of different resonant frequencies.

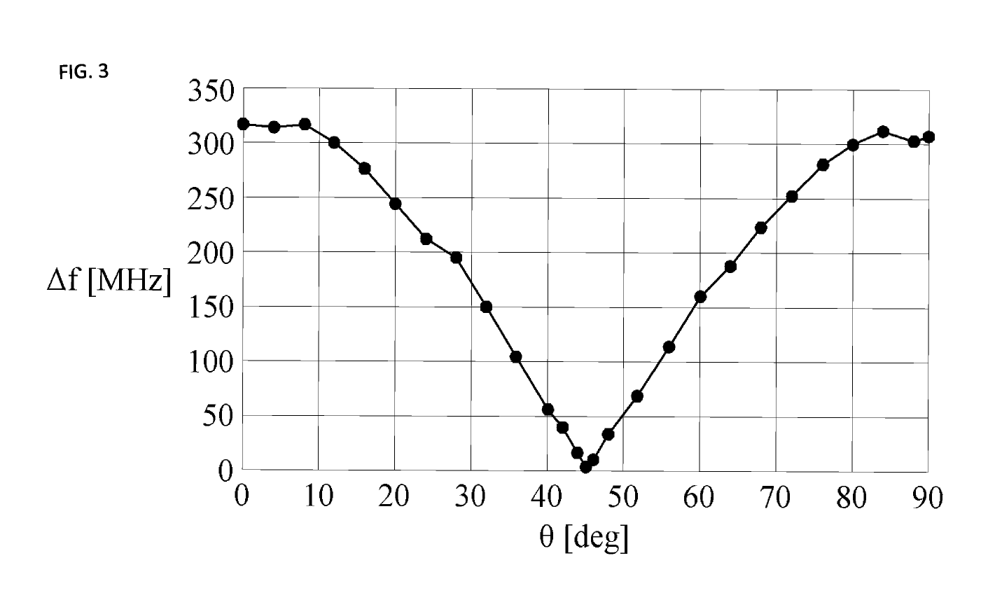

The plurality of slot irises 130 may be formed on a side of the cylindrical cavity 120, and may have different widths and lengths. The plurality of slot irises 130 connected to the cylindrical cavity 120 may be arranged asymmetrically to each other with respect to the cylindrical cavity 120. In other words, the plurality of slot irises 130 may not face each other, and an angle between the slot irises 130 may be less than 180 degrees. Based on the angle between the slot irises 130 in the filter 100, a difference between the different resonant frequencies formed in the cylindrical cavity 120 may be determined, which will be further described with reference to FIG. 3.

In the filter 100 of FIG. 1, the cylindrical cavity 120 may implement two resonance modes 110, and two slot irises 130 may be formed on the side of the cylindrical cavity 120. In the filter 100, the different resonant frequencies formed by the cylindrical cavity 120 may be simultaneously changed by moving either a top or a bottom of the cylindrical cavity 120 or both. In FIG. 1, the piston 140 may vertically move to change the resonant frequencies.

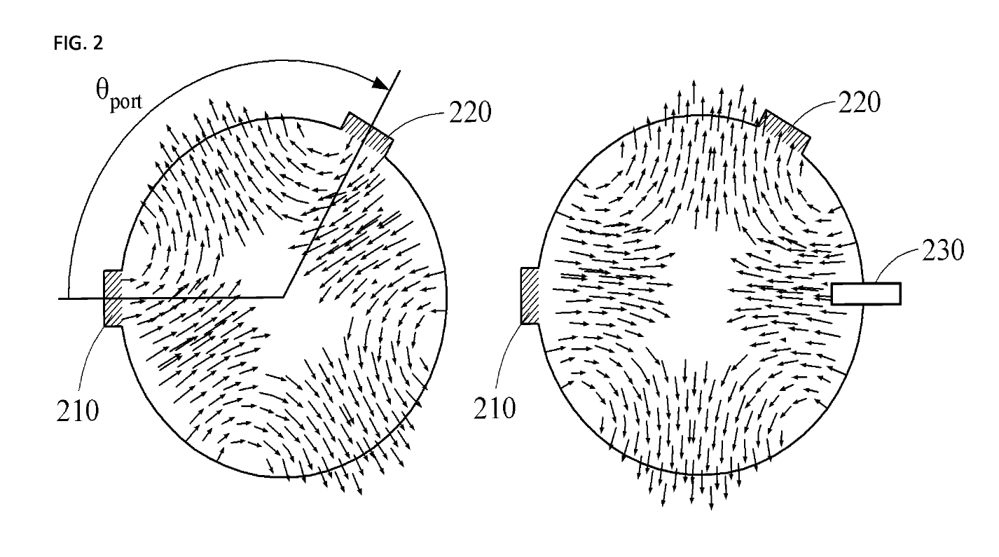

FIG. 2 is a diagram illustrating two TE₂₁₁ modes that have different resonant frequencies and in which slot irises are arranged at a specific angle on a side of a cylindrical cavity according to an embodiment.

Generally, to reduce a weight and a size of a filter, a dual-mode filter may be used. The dual-mode filter may refer to a filter that implements two resonance modes instead of a single resonance mode using a single cavity. In other words, unlike existing mechanically tunable filters, a dual-mode microwave filter according to an embodiment may be manufactured by implementing a plurality of resonance modes using a single cavity, and thus it is possible to implement a relatively small and lightweight band-pass filter.

According to an embodiment, the TE₂₁₁ mode may be used to manufacture a dual-mode microwave filter, whereas existing tunable filters may use a TE₀₁₁ mode. The TE₂₁₁ mode has periodicity in a circumferential direction as shown in FIG. 2, even though the TE₂₁₁ mode has a quality (Q)-factor less than that of the TE₀₁₁ mode, and accordingly slot irises may be formed at a specific angle, which may implement a dual-mode filter by breaking the periodicity. In the present disclosure, the TE₂₁₁ mode is used to manufacture a dual-mode microwave filter, however, there is no limitation thereto. For example, a TE₃₁₁ mode, a TE₄₁₁ mode or a TEₙ₁₁ mode may also be used to manufacture a dual-mode microwave filter.

Even though a cylindrical cavity has an elliptical cross section, two TE₂₁₁ modes with different resonant frequencies may be generated. However, an elliptical cavity may not be practically used, because it is difficult to precisely process the elliptical cavity. Accordingly, embodiments may provide a method of generating two TE₂₁₁ modes with different resonant frequencies by forming slot irises 210 and 220 to be asymmetric to each other as shown in FIG. 2.

A difference between the different resonant frequencies of the two TE₂₁₁ modes may be determined based on relative positions of a plurality of slot irises, for example, the slot irises 210 and 220, formed on a side of the cylindrical cavity 120. An angle θₚₒᵣₜ between the slot irises 210 and 220 connected to the side of the cylindrical cavity 120 may be used to determine the difference between the different resonant frequencies. For example, the angle θₚₒᵣₜ between the slot irises 210 and 220 may be less than 180 degrees. In other words, the slot irises 210 and 220 may not face each other.

The difference between the different resonant frequencies determined based on the angle θₚₒᵣₜ between the slot irises 210 and 220 may be verified with reference to FIG. 3. FIG. 3 illustrates a difference between two different resonant frequencies determined based on a change in an angle θ between slot irises formed in a side of a cylindrical cavity in a filter in which two resonance modes are implemented in the cylindrical cavity. For example, when the angle θₚₒᵣₜ is 45 degrees, the two resonant frequencies may have the same value, and the difference between the two resonant frequencies may be “0.” When the angle θₚₒᵣₜ is an angle other than 45 degrees, the difference between the two resonant frequencies may increase.

The filter 100 of FIG. 1 may further include a tuning screw 230 inserted into the cylindrical cavity 120. The tuning screw 230 may adjust the difference between the different resonant frequencies formed by the cylindrical cavity 120, together with the slot irises 210 and 220 formed on the side of the cylindrical cavity 120. Also, the tuning screw 230 may adjust the difference between the different resonant frequencies, independently of the slot irises 210 and 220.

The difference between the two different resonant frequencies may be adjusted based on a diameter of the tuning screw 230 or a depth by which the tuning screw 230 is inserted into the cylindrical cavity 120. Also, the difference between the two different resonant frequencies may be adjusted based on a position of the tuning screw 230 inserted into the cylindrical cavity 120.

In addition, the filter 100 may further include a separate groove formed on the side of the cylindrical cavity 120 to adjust the difference between the different resonant frequencies. The groove may not be connected to a separate cavity unlike the slot irises 210 and 220 even though the groove has a similar shape to those of the slot irises 210 and 220. Different resonant frequencies formed by the cylindrical cavity 120 may be adjusted based on a length, a width and a position of the groove, or a depth by which the groove is formed in the cylindrical cavity 120.

For example, the filter 100 may increase a resonant frequency formed by the cylindrical cavity 120 by inserting the tuning screw 230 into the cylindrical cavity 120. In another example, the filter 100 may reduce a resonant frequency formed by the cylindrical cavity 120 by additionally forming a separate groove on the side of the cylindrical cavity 120.

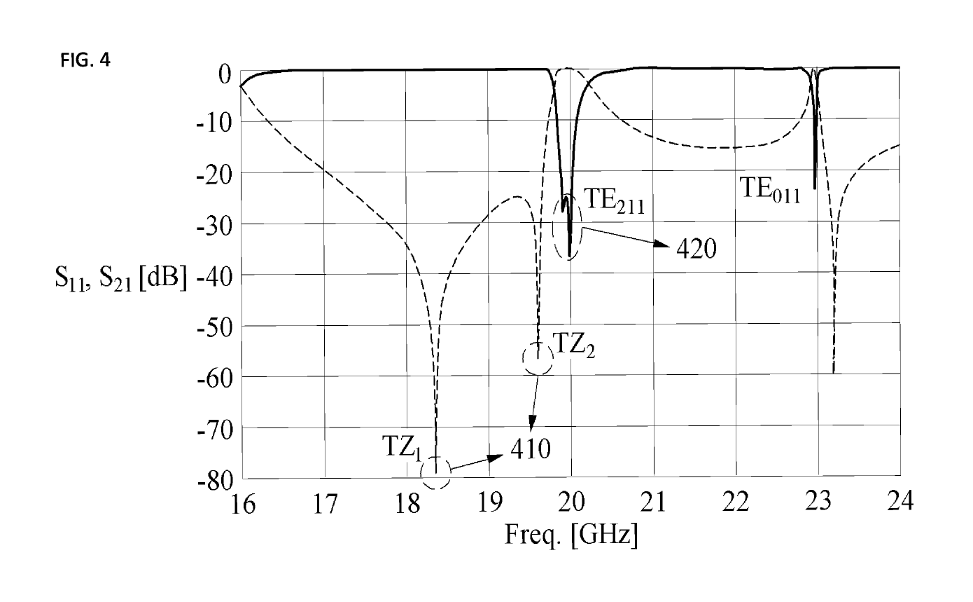

FIG. 4 is a graph illustrating a result of a design of a dual-mode microwave filter using TE₂₁₁ modes according to an embodiment.

The result of FIG. 4 may be acquired by adjusting a diameter and a height of a cavity, a width and a length of a slot iris, an angle between slot irises formed on a side of the cavity, and the like.

In FIG. 4, the microwave filter may have a structure of FIG. 1. For example, when two TE₂₁₁ modes are used in a filter including two resonance modes in a single cavity, two transmission zeros 410 and two reflection zeros 420 may be formed. Basically, a filter having a coupling structure shown in a lower portion of FIG. 1 may theoretically have two reflection zeros and a single transmission zero. However, an additional transmission zero may be generated by an offsetting action between the TE₂₁₁ mode and a TE₁₁₁ mode that is implemented at a frequency lower than a resonant frequency of the TE₂₁₁ mode. A phenomenon in which an electromagnetic field offsets may occur due to a difference of 180 degrees between a phase of the TE₁₁₁ mode and a phase of the TE₂₁₁ mode at a specific frequency, which may be represented as a transmission zero. A newly added transmission zero may be denoted by TZ₁.

A frequency of the transmission zero TZ₁ may be determined based on the angle θₚₒᵣₜ between the slot irises 210 and 220, and a rejection frequency band may be widened by the transmission zero TZ₁.

A transmission zero TZ₂ may be formed by coupling between resonance modes shown in the lower portion of FIG. 1, and a resonance of a TE₀₁₁ mode may occur at a frequency higher than the resonant frequency of the TE₂₁₁ mode.

The dual-mode microwave filter implemented using the two TE₂₁₁ modes may be reduced in size and may have a wide passband in comparison to a filter using two TE₀₁₁ modes.

The filter 100 of FIG. 1 may have various advantages, for example, a volume, a weight, a wide passband and a wide rejection bandwidth, due to use of the two TE₂₁₁ modes, however, may need to realize a higher roll-off at an edge of a passband. The roll-off may refer to a slope of a filter in which a transfer coefficient decreases at an edge of a passband. Thus, the filter 100 may more efficiently use a given frequency band by implementing a high roll-off.

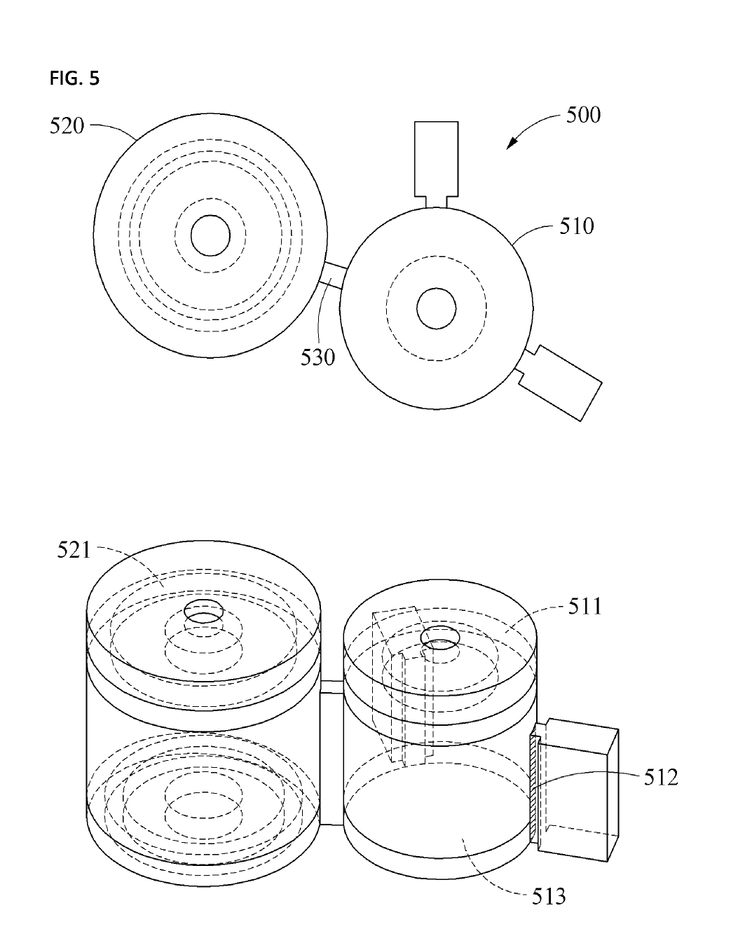

FIG. 5 is a diagram illustrating a shape of a filter 500 including a TE₀₁₁ mode cavity to add a transmission zero according to an embodiment.

To implement a higher roll-off, an additional cavity 520 to add a transmission zero may be connected to a basic filter 510 using a slot iris 530. For example, the basic filter 510 may have the same configuration as that of the filter 100 of FIG. 1, and the additional cavity 520 may implement a resonance mode to add a transmission zero to the basic filter 510.

The filter 500 may simultaneously change all a plurality of resonant frequencies implemented by a cylindrical cavity 513 included in the basic filter 510 and by the additional cavity 520, by simultaneously moving either a top or a bottom of each of the cylindrical cavity 513 and the additional cavity 520 or both. Thus, it is possible to change a center frequency while minimizing a change in a bandwidth or a cutoff characteristic by simultaneously moving either a top or a bottom of each of cavities when a performance of a filter is implemented at an intermediate frequency of a frequency range to be changed.

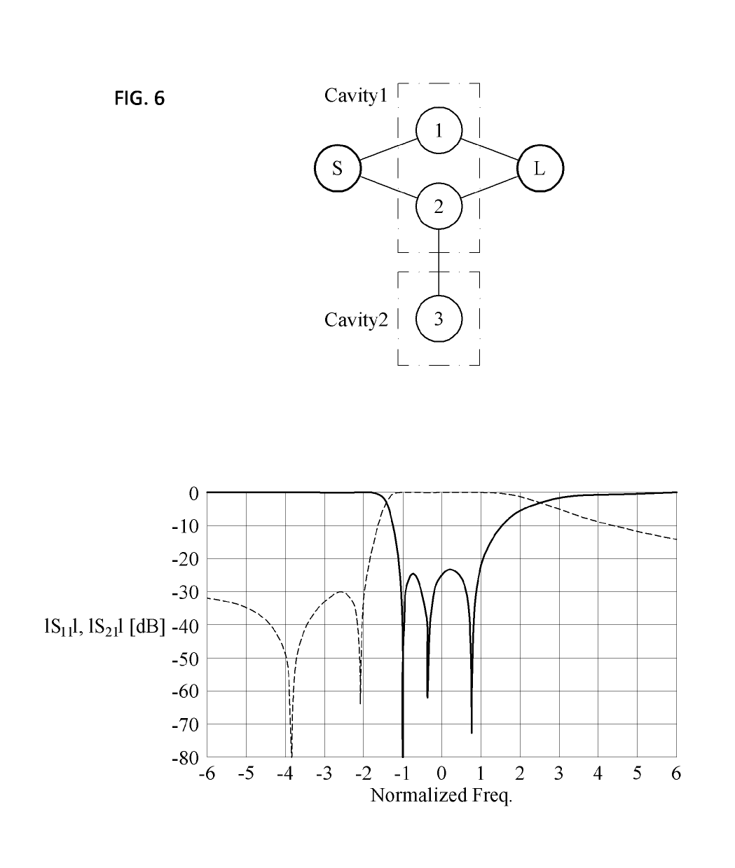

FIG. 6 illustrates a filter coupling structure to add a transmission zero, and a filter design result according to an embodiment.

FIG. 6 shows a characteristic of a filter generated by connecting the additional cavity 520 to the basic filter 510 to implement a high roll-off. The additional cavity 520 may be implemented in a single mode, for example, a TE₀₁₁ mode with a high Q-factor. Referring to a graph of FIG. 6, a single transmission zero and a single reflection zero may be generated in addition to a single transmission zero and two reflection zeros generated by the basic filter 510. An additional transmission zero generated by an offsetting action between the TE₁₁₁ mode and the TE₂₁₁ mode is not shown in the graph of FIG. 6.

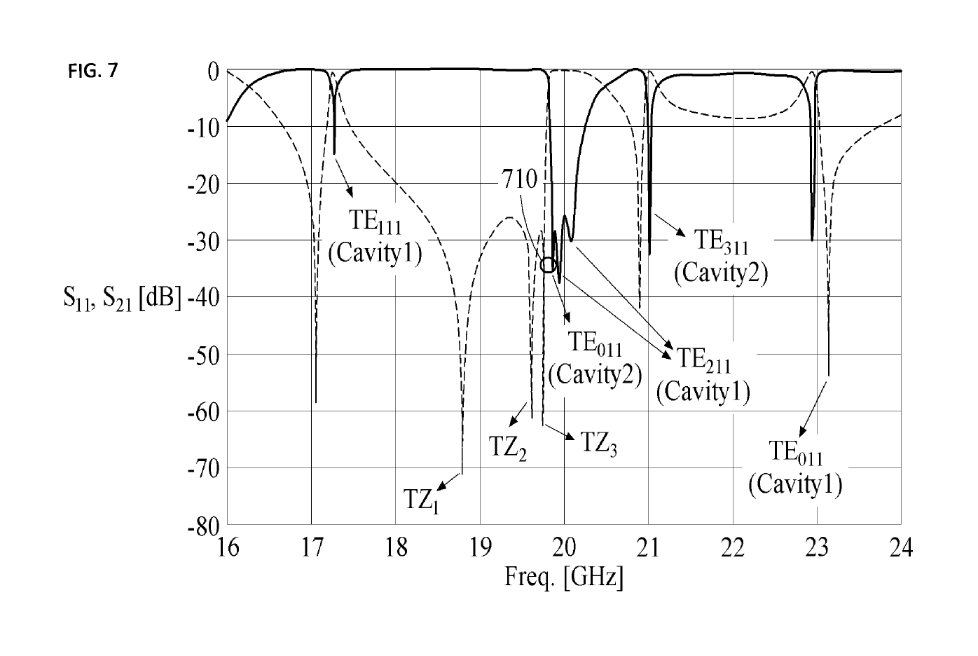

FIG. 7 is a graph illustrating a result of a design of a filter having a higher roll-off due to an addition of a TE₀₁₁ mode according to an embodiment.

In FIG. 7, transmission zeros TZ₁ and TZ₂ may be generated by the basic filter 510 of FIG. 5. The transmission zero TZ₂ may be generated by a structure of coupling of resonance modes in the basic filter 510, and the transmission zero TZ₁ may be an additional transmission zero generated by an offsetting action between the TE₁₁₁ mode and the TE₂₁₁ mode. The TE₁₁₁ mode may be implemented at a frequency lower than a resonant frequency of the TE₂₁₁ mode implemented in the cylindrical cavity 513 of the basic filter 510.

A transmission zero TZ₃ may be a transmission zero additionally generated by connecting the basic filter 510 to the additional cavity 520 that implements the TE₀₁₁ mode. A reflection zero 710 closest to the transmission zero TZ₃ may also be a transmission zero additionally generated by connecting the basic filter 510 to the additional cavity 520.

To add a single transmission zero and a single reflection zero, the additional cavity 520 that implements the TE₀₁₁ mode with the high Q-factor may be connected to the basic filter 510. However, an additional cavity to implement the TE₂₁₁ mode or the TE₁₁₁ mode may be used, and for example, a hexahedral cavity may be used.

The filter 500 designed as described above may simultaneously change central frequencies corresponding to a plurality of different resonant frequencies implemented by the cylindrical cavity 513 included in the basic filter 510 and the additional cavity 520 by simultaneously moving either a top or a bottom of each of the cylindrical cavity 513 and the additional cavity 520 or both.

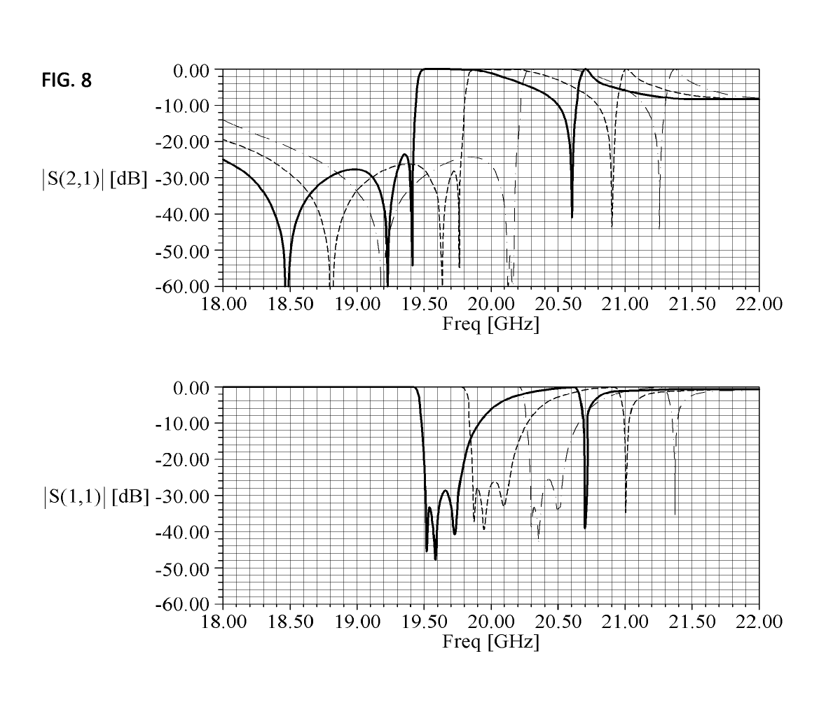

Referring to FIG. 8, central frequencies corresponding to two different resonant frequencies may simultaneously change based on vertical movements of pistons 511 and 521 of the filter 500.

As found in existing research, when a length of a slot iris is shorter than a half-wave length of a used frequency, an amount of coupling of the slot iris may slightly change based on a change in a height of a cavity. According to an embodiment, the amount of coupling may slightly change based on the change in the height of the cavity due to use of only a relatively long slot iris, and thus it is possible to have a wide tuning range.

According to an embodiment, because the TE₂₁₁ mode is used, a size of a cavity may be reduced in comparison to when the TE₀₁₁ mode is used. Also, because a dual-mode filter is used, a size and a weight of the dual-mode filter may be reduced due to a reduction in a number of cavities. In addition, when the TE₂₁₁ mode is used, a wider bandwidth may be implemented without a change in a number of resonance modes, in comparison to when the TE₀₁₁ mode is used. Furthermore, a higher roll-off may be implemented by adding the TE₀₁₁ mode, and an additional transmission zero may be implemented based on an offsetting action with a spurious mode adjacent to the TE₂₁₁ mode. Thus, it is possible to widen a rejection bandwidth.

According to an embodiment, a degenerate mode may not exist due to use of the TE₂₁₁ mode, and accordingly an effort to remove the degenerate mode may not be required. Also, a performance of a filter implemented as described above may be maintained despite a change in a central frequency in a band of a considerable wide range.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A filter comprising:
a cylindrical cavity configured to implement resonance modes with a plurality of different resonant frequencies; and
a plurality of slot irises formed on a side of the cylindrical cavity,
wherein a difference between the plurality of different resonant frequencies is determined based on relative positions of the plurality of slot irises, and
wherein the filter is configured to add a transmission zero by inducing an offsetting action between a used mode and a neighboring mode by adjusting the relative positions of the plurality of slot irises.

2. The filter of claim 1, wherein the plurality of slot irises are arranged asymmetrically to each other with respect to the cylindrical cavity.

3. The filter of claim 1, wherein the plurality of different resonant frequencies are simultaneously changed by moving either a top or a bottom of the cylindrical cavity or both.

4. The filter of claim 1, further comprising a tuning screw inserted into the side of the cylindrical cavity,
wherein the difference between the plurality of different resonant frequencies is adjusted based on a diameter of the tuning screw or a depth by which the tuning screw is inserted into the cylindrical cavity.

5. A filter comprising:
a basic filter; and
an additional cavity configured to add a transmission zero to the basic filter,
wherein the basic filter comprises:
a cylindrical cavity configured to implement a resonance mode with a plurality of different resonant frequencies; and
a plurality of slot irises formed on a side of the cylindrical cavity,
wherein a difference between the plurality of different resonant frequencies is determined based on relative positions of the plurality of slot irises, and
wherein the basic filter is configured to add a transmission zero by inducing an offsetting action between a used mode and a neighboring mode by adjusting the relative positions of the plurality of slot irises, and
wherein the basic filter and the additional cavity are connected through a slot iris.

6. The filter of claim 5, wherein the additional cavity has a cylindrical shape.

7. The filter of claim 5, wherein the additional cavity has a hexahedral shape.

8. The filter of claim 5, wherein the plurality of slot irises are arranged asymmetrically to each other with respect to the cylindrical cavity in the basic filter.

9. The filter of claim 5, wherein central frequencies corresponding to the different resonant frequencies is changed by moving either a top or a bottom of the cylindrical cavity in the basic filter or both and simultaneously moving one surface or a plurality of surfaces of the additional cavity.

10. The filter of claim 5, further comprising a tuning screw inserted into the side of the cylindrical cavity in the basic filter,
wherein the difference between the plurality of different resonant frequencies is adjusted based on a diameter of the tuning screw or a depth by which the tuning screw is inserted into the cylindrical cavity.
